(19) United States
(12) Patent Application Publication
(10) Pub. No.: US 2008/0155084 A1
(43) Pub. Date: Jun. 26, 2008

(54) REMOTE LOGGING, ANALYSIS, REPORTING AND MANAGEMENT OF NETWORK SECURITY APPLIANCES

(75) Inventors: ZhouZhong (Joe) Yu, Vancouver (CA); Ken Xie, Atherton, CA (US); Michael Xie, Pleasanton, CA (US); Zhen Zhang, Coquitlam (CA); Yanni K. Dubuc, Coquitlam (CA); Yu (Michael) Fang, Burnaby (CA)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: FORTINET, INC.

(21) Appl. No.: 11/945,209

(22) Filed: Nov. 26, 2007

Related U.S. Application Data
(60) Provisional application No. 60/867,185, filed on Nov. 25, 2006.

(51) Int. Cl. G06F 15/173

(52) U.S. Cl. 709/223

(57) ABSTRACT

Methods, systems and business models are provided for hosted services for network security appliances. According to one embodiment an analysis and management network provides secure access and analysis of centralized logs. The analysis and management network may also support delivery, viewing and reporting of network security related activities as well as support configuration and management of network security appliances via a communications network, such as the Internet.

### CROSS-REFERENCE TO RELATED APPLICATIONS

This application claims the benefit of U.S. Provisional Application No. 60/867,185 filed on Nov. 25, 2006, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006-2007 Fortinet, Inc.

### BACKGROUND

1. Field

Embodiments of the present invention generally relate to systems and methods for providing hosted services for network security appliances. In particular, various embodiments relate to providing secure access and analysis of the centralized logs, delivering, viewing and reporting network security related activities and items to various clients and supporting configuration and management of network security appliances via a communications network, such as the Internet.

2. Description of Related Art

At present, network security activities and items on network gateway appliances are obtained, logged, accessed, analyzed and viewed locally at the customer's premises. The system that stores the logged data and information belongs to and resides with the customer. By analogy, this is as if the customer has a private bank. Management and configuration of network security appliances is also performed locally via on-site network security appliance management devices.

The current approaches for logging, analyzing, reporting and managing network security appliances requires customers to invest in network security data bank and management infrastructure and requires customers to hire employees or contractors or otherwise develop expertise to operate the network security data bank, analyze and interpret the network security related data and information and manage and configure their network security appliances.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 illustrates a dedicated analysis network for logging and reporting in accordance with one embodiment of the present invention.

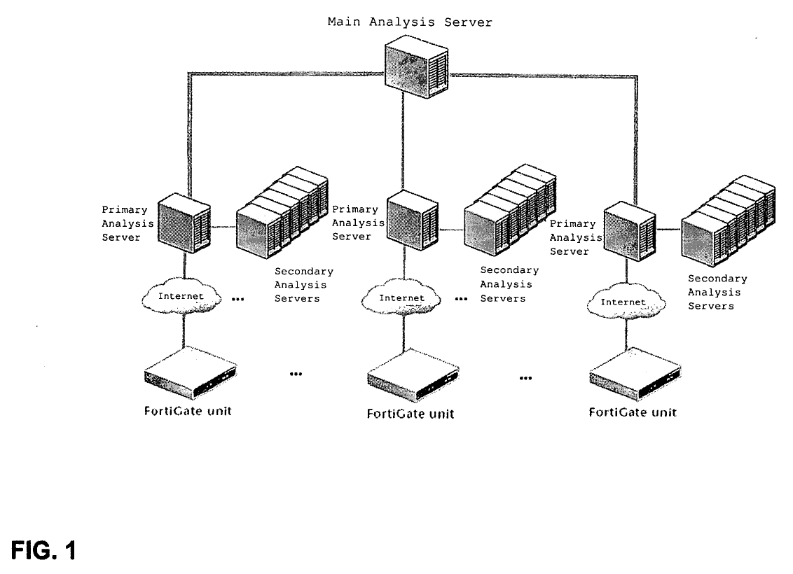

### SUMMARY

Methods and systems are described for providing hosted logging, analysis, reporting and management of network security appliances. According to one embodiment an analysis and management network provides secure access and analysis of centralized logs. The analysis and management network may also support delivery, viewing and reporting of network security related activities as well as support configuration and management of network security appliances via a communications network, such as the Internet.

Other features of embodiments of the present invention will be apparent from the accompanying drawings and from the detailed description that follows.

### DETAILED DESCRIPTION

Systems and methods are described for a subscription-based log analysis and management service. According to one embodiment, a customer's network gateway security related data and information are transmitted to/from a remote log server in a controlled and secured manner. Configuration information for the customer's network security appliances may also be stored and accessed remotely via a communications network, such as the Internet. In this manner, operation and maintenance of the remote, centralized network security data bank can be performed by a service provider that owns and/or operates the remote log server(s). Similarly, on a fee-for-service or subscription basis, depending on the revenue model, the service provider that owns and/or operates the remote log server(s), may also perform analysis and interpretation of the network security related data on behalf of its customers. According to one embodiment, an active communication protocol connection is maintained between customers' gateways and the remote centralized log server(s).

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, various embodiments of the present invention may be described with reference to use of existing analysis techniques, such as the forensic analysis, traffic summaries, security events, reports, alerts, network analysis and vulnerability scanning performed by a FortiAnalyzer™ system available from Fortinet, Inc. of Sunnyvale, Calif. and with reference to use of existing management and configuration techniques, such as configuring and managing virtual private network (VPN) policies, monitoring the status of network security appliances and updating firmware images of the managed devices performed by a FortiManager™ system available from Fortinet, Inc. of Sunnyvale, Calif., the present invention is equally applicable to various other current and future mechanisms for managing and configuring network security appliances and analyzing, interpreting and reporting network security related data and information on behalf of customers. The following FortiAnalyzer and FortiManager reference materials are hereby incorporated by reference for all purposes: (i) FortiAnalyzer CLI Reference Version 3.0 MR5, Aug. 24, 2007 (currently available for download at http://docs.forticare.com/fa/FortiAnalyzer_CLIRef_{—}05-30005-0288-20070824.pdf); (i) FortiAnalyzer Administration Guide Version 3.0 MR5, Aug. 17, 2007 (currently available for download at http://docs.forticare.com/fa/FortiAnalyzer_Admin_Guide_{—}05-30005-0082-20070817.pdf); (iii) FortiManager CLI Reference Version 3.0 MR4, Mar. 23, 2007 (currently available for download at http://docs.forticare.com/fmgr/FortiManager_CLI_Reference 02-30004-0227-20070323.pdf); and (iv) FortiManager System Administration Guide Version 3.0 MR5, Jul. 25, 2007 (currently available for download at http://docs.forticare.com/fmgr/FortiManager Admin Guide 02 30005 0149 2007072.zip).

For the sake of illustration, various embodiments of the present invention are described herein in the context of various FortiGate (FGT) network security devices available from Fortinet, Inc. of Sunnyvale, Calif. It should be apparent, however, that the methodologies described herein are broadly applicable to network devices of other vendors.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be couple directly, or via one or more intermediary media or devices. As another example, devices may be coupled in such a way that information can be passed there between, while not sharing any physical connection on with another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

### Technology Background/Overview

According to one embodiment of the present invention a subscription-based log analysis service is provided. A remote network security data bank is established by securely transferring (over a VPN tunnel, for example) logs of traffic and files passing through network gateway appliances and devices (e.g., network firewalls) of customers to remote log servers over an active communication protocol connection between the customers' gateways and the log servers. A real-time network logging, analyzing, and reporting system associated with the remote log servers may then securely aggregate and analyze the customers' log data.

In one embodiment, the analysis and reporting provides network administrators with a comprehensive view of network usage and security information and allows vulnerabilities within customer networks to be discovered and addressed. According to one embodiment, log records accepted, stored and analyzed by the remote log servers include traffic, event, virus, attack, content filtering, and email filtering data. The remote analysis may also provide advanced security management functions such as quarantine archiving, event correlation, vulnerability assessments, traffic analysis, and content archiving. In one embodiment, the log analysis functionality provides customers that may not be able to afford their own network security data bank a central point for consistent analysis of network utilization, Web activity and attack activity throughout their network.

According to one embodiment, when executing a forensic analysis user search, the remote log server analyzer retrieves user information from the following logs:
Email logs
Instant Message logs
FTP transfer logs
HTML download logs

The remote log server analyzer searches the content log (clog) for email, FTP, and HTML information. The remote log server analyzer searches the instant message log (ilog) for instant message information.

In one embodiment, there are two types of reports generated by the remote log server analyzer for forensic analysis: User Website Access and User Blocked Website Access Both reports use data from the wlog.

According to one embodiment, as logs/files are received from customers, the remote log server analyzer indexes the log messages. In one embodiment, the remote log server analyzer indexes nearly all fields in a log message to include in a database.

According to one embodiment, there are many reporting functions, including one or more of the following:
security event reports
traffic summary reports
regular reports whose complexity can vary depending on the requirements
quota checking with log rolling
network sniffing
vulnerability scan.

Report types may include one of more of the following:
Intrusion Activity (19)
   1. Attacks by Direction and Top Attack Types
   2. Attacks by Direction and Top Source IP
   3. Attacks by Date and Top Attack Types
   4. Attacks by Month and Top Attack Types
   5. Attacks by Day of Week and Top Attack Types
   6. Attacks by Hour of Day and Top Attack Types
   7. Attacks by Top Attack Types
   8. Attacks by Top Attack Types and Target Device
   9. Attacks by Attack Destination and Top Attack Types
   10. Attacks by Attack Destination and Top Attack Source IP
   11. Attacks by Top Attack Types and Top Attack Source IP
   12. Attacks by Target Device and Top Attack Types
   13. Attacks By Category
   14. IPS Status
   15. Attacks By Day
   16. Top Sources Of Attacks
   17. Top Destinations of Attacks
   18. Top Attacks by Protocol
   19. Top Attacks by Destination
AntiVirus Activity (69)
   1. Virus by Direction and Top Viruses
   2. Virus by Direction and Top Source IP
   3. Top Viruses
   4. Top Viruses by Date
   5. Top Viruses by Month
   6. Top Viruses by Day of Week
   7. Top Viruses by Hour of Day
   8. Top Viruses by Top Sources
   9. Top Viruses by Top Destinations
   10. Top Files
   11. Top Files by Date
   12. Top Files by Month
   13. Top Files by Day of Week
   14. Top Files by Hour of Day
   15. Top Files by Top Sources
   16. Top Files by Top Destinations
   17. Total AV Events by Date and AV Event Type
   18. Total AV Events by Month and AV Event Type
   19. Total AV Events by Day of Week and AV Event Type
   20. Total AV Events by Hour of Day and AV Event Type
   21. Total AV Events by Device and AV Event Type
   22. Total AV Events by Service and AV Event Type
   23. AV Events by Top Senders and AV Event Type
   24. AV Events by Top Senders and Virus Name
   25. AV Events by Top Receivers and AV Event Type
   26. AV Events by Top Source IP and AV Event Type
   27. AV Events by Top Target IP and AV Event Type
   28. All Protocols Top File Extensions Blocked by Month
   29. All Protocols Top Virus Sources by Hour of Day
   30. All Protocols Top Virus Sources by Day
   31. All Protocols Top Virus Sources by Month
   32. All Protocols Top Virus Destinations by Hour of Day
   33. All Protocols Top Virus Destinations by Day
   34. All Protocols Top Virus Destinations by Month
   35. IMAP Top File Extensions Blocked by Month
   36. IMAP Top Virus Sources by Hour of Day
   37. IMAP Top Virus Sources by Day
   38. IMAP Top Virus Sources by Month
   39. IMAP Top Virus Destinations by Hour of Day
   40. IMAP Top Virus Destinations by Day
   41. IMAP Top Virus Destinations by Month
   42. POP3 Top File Extensions Blocked by Month
   43. POP3 Top Virus Sources by Hour of Day
   44. POP3 Top Virus Sources by Day
   45. POP3 Top Virus Sources by Month
   46. POP3 Top Virus Destinations by Hour of Day
   47. POP3 Top Virus Destinations by Day
   48. POP3 Top Virus Destinations by Month
   49. FTP Top File Extensions Blocked by Month
   50. FTP Top Virus Sources by Hour of Day
   51. FTP Top Virus Sources by Day
   52. FTP Top Virus Sources by Month
   53. FTP Top Virus Destinations by Hour of Day
   54. FTP Top Virus Destinations by Day
   55. FTP Top Virus Destinations by Month
   56. HTTP Top File Extensions Blocked by Month
   57. HTTP Top Virus Sources by Hour of Day
   58. HTTP Top Virus Sources by Day
   59. HTTP Top Virus Sources by Month
   60. HTTP Top Virus Destinations by Hour of Day
   61. HTTP Top Virus Destinations by Day
   62. HTTP Top Virus Destinations by Month
   63. SMTP Top File Extensions Blocked by Month
   64. SMTP Top Virus Sources by Hour of Day
   65. SMTP Top Virus Sources by Day
   66. SMTP Top Virus Sources by Month
   67. SMTP Top Virus Destinations by Hour of Day
   68. SMTP Top Virus Destinations by Day
   69. SMTP Top Virus Destinations by Month
WebFilter Activity (46)
   1. Top Exempted Web Sites
   2. Top Blocked Web Sites
   3. Top Client Attempts To Blocked Web Sites
   4. Total WebFilter Events by Status
   5. Blocked Web Site Attempts by Date
   6. Blocked Web Site Attempts by Month
   7. Blocked Web Site Attempts by Day of Week
   8. Blocked Web Site Attempts by Hour of Day
   9. WebFilter Events by Date and Top Destinations
   10. WebFilter Events by Month and Top Destinations
   11. WebFilter Events by Day of Week and Top Destinations
   12. WebFilter Events by Hour of Day and Top Destinations
   13. WebFilter Events by Date and Top URLs
   14. WebFilter Events by Month and Top URLs
   15. WebFilter Events by Day of Week and Top URLs
   16. WebFilter Events by Hour of Day and Top URLs
   17. WebFilter Events by Date and Status
   18. WebFilter Events by Month and Status
   19. WebFilter Events by Day of Week and Status
   20. WebFilter Events by Hour of Day and Status
   21. WebFilter Events by Device and Top Sources
   22. WebFilter Events by Top Sources and Status
   23. WebFilter Events by Top Destinations and Status
   24. WebFilter Events by Top URLs and Status
   25. Top Blocked Categories
   26. Top Categories by Hits
   27. Category by Hits
   28. Disposition by Occurrences
   29. Top File Types by Hits
   30. Top Blocked Risks
   31. Top Risks
   32. User Destination Summary
   33. Top Blocked Users
   34. Top Users by Hits
   35. User Category and URL
   36. Permitted Activity by Hour
   37. Permitted Activity by Date
   38. Permitted Activity by Month
   39. Blocked Activity by Hour
   40. Blocked Activity by Date
   41. Blocked Activity by Month
   42. Top Blocked Sites
   43. Top Client Attempts to Blocked Sites
   44. Top Client Requests to Permitted Sites
   45. Top Client Attempts to Blocked Categories
   46. Top Client Requests to Permitted Categories
AntiSpam Activity (12)
   1. AntiSpam Events by Date and Top Senders
   2. AntiSpam Events by Month and Top Senders
   3. AntiSpam Events by Days of Week and Top Senders
   4. AntiSpam Events by Hour of Day and Top Senders
   5. AntiSpam Events by Device and Top Senders
   6. AntiSpam Events by Device and Top Receivers
   7. Total AntiSpam Events by Device and Block Criteria
   8. Top Mail Senders
   9. Top Blocked Mail Senders
   10. Top Mail Receivers
   11. Top Blocked Mail Receivers
   12. Top Mail Receivers and Their Top Senders
IM Activity (12)
   1. IM Activity by Date and Action
   2. IM Activity by Month and Action
   3. IM Activity by Day of Week and Action
   4. IM Activity by Hour of Day and Action
   5. Top Permitted Sources by Date
   6. Top Permitted Sources by Month
   7. Top Blocked Sources by Date
   8. Top Blocked Sources by Month
   9. Top Permitted Remote Users by Date
   10. Top Permitted Remote Users by Month
   11. Top Blocked Remote Users by Date
   12. Top Blocked Remote Users by Month
Content Activity (21)
   1. Content Traffic by Date and Service
   2. Content Traffic by Month and Service
   3. Content Traffic by Date and Status
   4. Content Traffic by Month and Status
   5. Content Traffic by Date and Top Viruses
   6. Content Traffic by Month and Top Viruses
   7. Content Traffic by Day of Week and Service
   8. Content Traffic by Day of Week and Status
   9. Content Traffic by Day of Week and Top Viruses
   10. Content Traffic by Hour of Day and Service
   11. Content Traffic by Hour of Day and Status
   12. Content Traffic by Hour of Day and Top Viruses
   13. Content Traffic by Status and Service
   14. Content Traffic by Service and Status
   15. Content Traffic by Service and Top Viruses
   16. Content Traffic by Top Clients and Service
   17. Content Traffic by Top Clients and Status
   18. Content Traffic by Top Clients and Top Viruses
   19. Content Traffic by Top Servers and Service
   20. Content Traffic by Top Servers and Status
   21. Content Traffic by Top Servers and Top Viruses
Network Activity (18)
   1. Top Denied Policies
   2. Top Denied Services
   3. Top Denied Sources
   4. Top Denied Destinations
   5. Traffic by Date and Direction
   6. Traffic by Month and Direction
   7. Traffic by Day of Week and Direction
   8. Traffic by Hour of Day and Direction
   9. Traffic by Direction
   10. Traffic by Top Services and Direction
   11. Traffic by Top Sources
   12. Traffic by Top Sources and Top Services
   13. Traffic by Top Sources and Top Destinations
   14. Traffic by Top Destinations
   15. Traffic by Top Destinations and Top Services
   16. Traffic by Top Destinations and Top Sources
   17. Top Destinations by Duration
   18. Top Users by Duration
Web Activity (22)
   1. Web Traffic by Date
   2. Web Traffic by Month
   3. Web Traffic by Day of Week
   4. Web Traffic by Hour of Day
   5. Web Traffic by Direction
   6. Top Web Sites (Connections)
   7. Top Web Sites (Traffic)
   8. Top Pages
   9. Top Pages by Top Sources
   10. Top Sources by Top Pages
   11. Top Web Clients (Connections)
   12. Top Web Clients (Traffic)
   13. Top Clients by Top Web Sites (Connections)
   14. Top Clients by Top Web Sites (Traffic)
   15. Web Traffic by Top Web Servers
   16. Web Traffic by Status and Top Web Servers
   17. Web Traffic by Top URLs
   18. Web Traffic by Status and Top URLs
   19. Top Web Sites by Duration
   20. Top Web Clients by Duration
   21. Top Clients and Top Web Sites by Duration
   22. Top Web Clients by Browse Time
Mail Activity (15)
   1. Mail Traffic by Date
   2. Mail Traffic by Month
   3. Mail Traffic by Day of Week
   4. Mail Traffic by Hour of Day
   5. Mail Traffic by Direction
   6. Top Mail Servers (Connections)
   7. Top Mail Servers (Traffic)
   8. Top Mail Clients (Connections)
   9. Top Mail Clients (Traffic)
   10. Top Mail Servers by Top Clients (Connections)
   11. Top Mail Servers by Top Clients (Traffic)
   12. Mail Traffic by Mail Service and Top Senders
   13. Mail Traffic by Mail Service and Top Receivers
   14. Mail Traffic by Status and Top Senders
   15. Mail Traffic by Status and Top Receivers
FTP Activity (11)
   1. FTP Traffic by Date
   2. FTP Traffic by Month
   3. FTP Traffic by Day of Week
   4. FTP Traffic by Hour of Day
   5. FTP Traffic by Direction
   6. Top FTP Sites (Connection)
   7. Top FTP Sites (Traffic)
   8. Top FTP Clients (Connection)
   9. Top FTP Clients (Traffic)
   10. Top Clients by Top FTP Sites (Connections)
   11. Top Clients by Top FTP Sites (Traffic)
Terminal Activity (14)
   1. Terminal Traffic by Date and Service
   2. Terminal Traffic by Month and Service
   3. Terminal Traffic by Day of Week and Service
   4. Terminal Traffic by Hour of Day and Service
   5. Telnet Traffic by Direction
   6. SSH Traffic by Direction
   7. Top Terminal Servers by Service (Connections)
   8. Top Terminal Servers by Service (Traffic)
   9. Top Terminal Clients by Service (Connections)
   10. Top Terminal Clients by Service (Traffic)
   11. Top Telnet Clients by Top Terminal Servers (Connections)
   12. Top Telnet Clients by Top Terminal Servers (Traffic)
   13. Top SSH Clients by Top Terminal Servers (Connections)
   14. Top SSH Clients by Top Terminal Servers (Traffic)
VPN Activity (17)
   1. Total VPN Activity by Date and Direction (traffic)
   2. Total VPN Activity by Month and Direction (traffic)
   3. Total VPN Activity by Day of Week and Direction (traffic)
   4. Total VPN Activity by Hour of Day and Direction (traffic)
   5. VPN Activity by Top Devices (tunnels)
   6. VPN Activity by Top Devices (traffic)
   7. VPN Activity by Top Devices and Top Peers (tunnels)
   8. VPN Activity by Top Devices and Top Peers (traffic)
   9. VPN Activity by Devices and Top Services (traffic)
   10. VPN Activity by Top Sources (traffic)
   11. VPN Activity by Top Destinations (traffic)
   12. Total VPN Activity by Direction (traffic)
   13. Total VPN Activity by Date and Top Tunnels (traffic)
   14. Total VPN Activity by Month and Top Tunnels (traffic)
   15. Total VPN Activity by Day of Week and Top Tunnels (traffic)
   16. Total VPN Activity by Hour of Day and Top Tunnels (traffic)
   17. Total VPN Activity by Top Tunnels (traffic)
Event Activity (25)
   1. Overall Events Triggered
   2. Overall Events Triggered By Category
   3. Overall Events Triggered By Type
   4. Critical Events Triggered By Hour
   5. Critical Events Triggered By Day
   6. Warning Events Triggered By Hour
   7. Warning Events Triggered By Day
   8. Informational Events Triggered By Hour
   9. Informational Events Triggered By Day
   10. Emergency Events Triggered By Hour
   11. Emergency Events Triggered By Day
   12. Alert Events Triggered By Hour
   13. Alert Events Triggered By Day
   14. Error Events Triggered By Hour
   15. Error Events Triggered By Day
   16. Notification Events Triggered By Hour
   17. Notification Events Triggered By Day
   18. Events By Device
   19. Events By Device By Category
   20. Events By Hour Of Day
   21. Hourly Events By Category
   22. Events By Day
   23. Daily Events By Category
   24. Events Status
   25. Event by Device and Type
P2P Activity (13)
   1. P2P Events by P2P Protocol
   2. P2P Activity by Date and Action
   3. P2P Activity by Month and Action
   4. P2P Activity by Day of Week and Action
   5. P2P Activity by Hour of Day and Action
   6. Top Permitted Sources by Date
   7. Top Permitted Sources by Month
   8. Top Blocked Sources by Date
   9. Top Blocked Sources by Month
   10. Top Permitted Remote Users by Date
   11. Top Permitted Remote Users by Month
   12. Top Blocked Remote Users by Date
   13. Top Blocked Remote Users by Month

In the attached Appendices, various aspects of a subscription-based log analysis and network device configuration and management service in accordance with various embodiments of the present invention are described and illustrated.

What is claimed is:

1. A remote, centralized analysis and management network supporting logging, reporting, analyzing, configuring and managing network devices as shown and described.

2. A method of logging, reporting, analyzing, configuring and managing network devices as shown and described.
